(19) United States
(12) Patent Application Publication
(10) Pub. No.: US 2006/0213536 A1
(43) Pub. Date: Sep. 28, 2006

(54) Substrate cleaning apparatus and substrate cleaning method

(75) Inventor: Masanobu Sato, Kyoto (JP)

Correspondence Address: OSTROLENK FABER GERB & SOFFEN, 1180 AVENUE OF THE AMERICAS, NEW YORK, NY, 100368403, US

(73) Assignee: DAINIPPON SCREEN MFG. CO., LTD.

(21) Appl. No.: 11/396,435

(22) Filed: Mar. 24, 2006

(30) Foreign Application Priority Data
Mar. 28, 2005 (JP) 2005-90761

(51) Int. Cl. B08B 7/04; A47L 25/00

(52) U.S. Cl. 134/6; 134/10; 15/77; 15/88.2

(57) ABSTRACT

In a substrate cleaning apparatus, first cleaning solution is applied onto a substrate from a cleaning nozzle and the substrate is scrubbed with a brush, whereby the substrate is cleaned. While cleaning of the substrate is not performed, second cleaning solution is applied to the brush from a cleaning solution nozzle provided in a container to clean the brush. Since the second cleaning solution used in the substrate cleaning apparatus is almost neutral at hydrogen ion exponent pH of 6.5, and a zeta potential of the brush in the second cleaning solution has the same polarity as a zeta potential of particles which have adhered to the brush while cleaning the substrate, it is possible to efficiently remove particles adhering to the brush during cleaning of the substrate with suppressing deterioration of the brush.

### BACKGROUND OF THE INVENTION

1. Field of the Invention

The present invention relates to a technique for cleaning a substrate with a brush.

2. Description of the Background Art

Conventionally, when cleaning of a semiconductor substrate or glass substrate (hereinafter, referred to as “substrate”) is performed, a drum-type or pen-type brush made of resin fiber has been used. While cleaning a substrate with a brush, predetermined cleaning solution is applied onto the substrate and the substrate is scrubbed with the brush, whereby the substrate is cleaned. However, particles which have adhered to the substrate are transferred to the brush and contaminate the brush, and while cleaning of a next substrate is performed, the substrate is contaminated by particles adhering to the brush. Then, techniques for cleaning a brush after cleaning of a substrate have been suggested. For example, Japanese Patent Application Laid Open Gazette No. 59-195650 (Document 1) discloses a technique for cleaning a brush by rotating the brush in cleaning solution. International Patent Publication No. WO 97/17147 (Document 2) discloses a technique for cleaning a brush with ammonium hydroxide (NH₄OH) solution of alkaline cleaning solution.

“Product Innovation Developed by Wet Science” (Mitsushi Itano, II-2 Mechanism of Particle Deposition and Removal in Wet Cleaning Processes, SIPEC Corporation, Japan, Jul. 28, 2001, pp. 42-53) discloses a technique for suppressing deposition of particles on a surface of a silicon substrate, where the silicon substrate is immersed in anionic surfactant solution, and a zeta potential of the surface of the silicon substrate and a zeta potential of particles adhered to the silicon substrate are controlled to become negative.

In the technique of Document 1, it is difficult to clean the brush efficiently without consideration of a relation between a zeta potential of the brush in the cleaning solution and a zeta potential of particles adhering to the brush while cleaning the substrate. In the technique of Document 2 where cleaning of the brush is performed with the alkaline cleaning solution, there arises a problem of rapid deterioration of resin fiber forming the brush because of the alkaline cleaning solution. Even if an anionic surfactant is used, in such a case, the brush deteriorates rapidly because general anionic surfactant solution is alkaline. Especially, in a case of cleaning where alkaline solution is unsuitable, it is not possible to utilize the above-described brush cleaning method.

### SUMMARY OF THE INVENTION

The present invention is intended for a substrate cleaning apparatus for cleaning a substrate. It is an object of the present invention to efficiently remove particles which have adhered to a brush during cleaning of a substrate with suppressing deterioration of the brush.

The substrate cleaning apparatus comprises a substrate cleaning mechanism for cleaning a substrate by applying first cleaning solution onto the substrate and scrubbing the substrate with a brush made of resin, and a brush cleaning mechanism for cleaning the brush by applying second cleaning solution to the brush while cleaning of a substrate with the brush is not performed, the second cleaning solution having hydrogen ion exponent pH which is not lower than 6.0 and not higher than 7.5, in the apparatus, a zeta potential of the brush in the second cleaning solution has the same polarity as a zeta potential of particles which have adhered to the brush while cleaning a substrate.

According to the present invention, it is possible to efficiently remove particles, which have adhered to a brush during cleaning of a substrate, with suppressing deterioration of the brush.

Preferably, the second cleaning solution includes an anionic surfactant, and the brush is made of polyvinyl alcohol or nylon.

According to a preferred embodiment of the present invention, the substrate cleaning apparatus further comprises a rinse agent applying part for applying a rinse agent to the brush to replace the second cleaning solution remaining on the brush with the rinse agent immediately after cleaning by the brush cleaning mechanism. This makes it possible to prevent a substrate from being affected by the second cleaning solution remaining on the brush.

According to an aspect of the present invention, the substrate cleaning apparatus further comprises a solution circulation part for collecting the second cleaning solution applied to the brush to supply the second cleaning solution to the brush cleaning mechanism after filtering the second cleaning solution, whereby the second cleaning solution applied to the brush can be used again.

The present invention is also intended for a substrate cleaning method for cleaning a substrate.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view showing a construction of a substrate cleaning apparatus;

FIG. 2 is a plan view showing the substrate cleaning apparatus;

FIG. 3 is an enlarged cross-sectional view showing the vicinity of a container;

FIG. 4 is a block diagram showing a construction of a solution circulation part;

FIG. 5 is an operation flow of the substrate cleaning apparatus for cleaning a substrate; and

FIG. 6 is a graph showing cleaning result of substrates.

### DESCRIPTION OF THE PREFERRED EMBODIMENTS

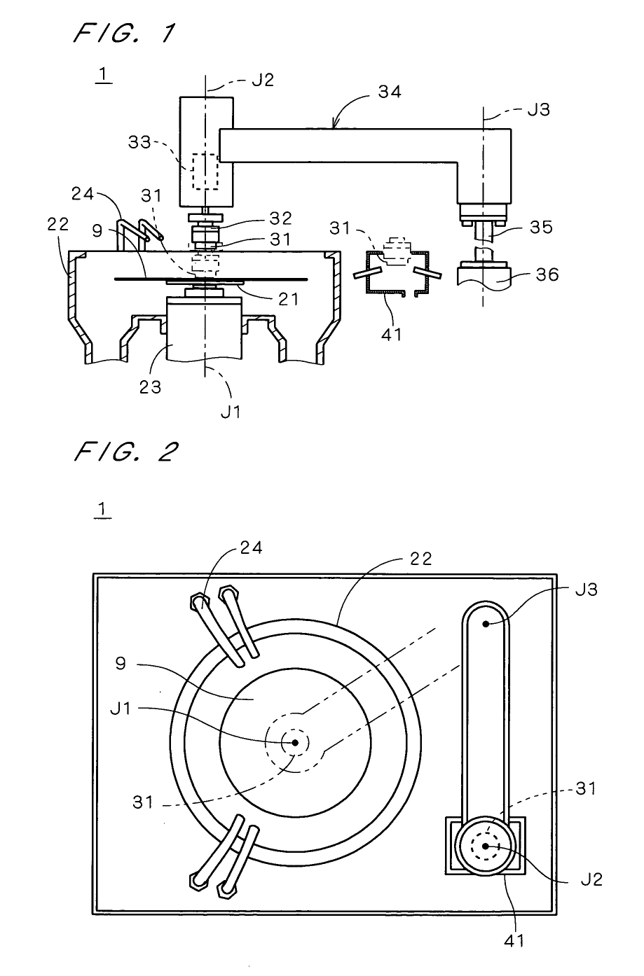

FIG. 1 is a front view showing a construction of a substrate cleaning apparatus 1 in accordance with a preferred embodiment of the present invention and FIG. 2 is a plan view showing the substrate cleaning apparatus 1. The substrate cleaning apparatus 1 is an apparatus for cleaning a substrate with a brush.

As shown in FIG. 1, the substrate cleaning apparatus 1 comprises a disk-shaped holding part 21 for holding a semiconductor substrate 9 horizontally, the substrate 9 being made of silicone (Si), and a cup 22 in which the holding part 21 is disposed and at the bottom of which a gas outlet and a liquid outlet are formed. The substrate 9 is held by the holding part 21 with a suction mechanism, a mechanical chuck, or the like. A shaft of a motor 23 is connected to a lower surface of the holding part 21 which is the opposite side of an upper surface facing the substrate 9. By driving the motor 23, the holding part 21 rotates around a central axis J1 of the motor 23 in a vertical direction. Above the cup 22, provided is a cleaning nozzle 24 which applies cleaning solution for cleaning a substrate onto an upper surface of the substrate 9 which is the other main surface of a lower surface opposed to the holding part 21. The cleaning solution is, for example, mixture of ammonia and hydrogen peroxide, pure water, or the like, and it is hereinafter referred to as “first cleaning solution”. It is also possible to discharge other cleaning solutions from other nozzles in FIG. 2 onto the substrate 9 as necessary.

The substrate cleaning apparatus 1 of FIG. 1 further comprises a brush 31 made of polyvinyl alcohol (PVA) fiber, and the brush 31 is connected to a motor 33 through a brush supporting part 32. The motor 33 is fixed to one end of a supporting arm 34 extending in a horizontal direction and a shaft 35 extending from the motor 36 is connected to the other end of the supporting arm 34. In the substrate cleaning apparatus 1, by driving the motor 33, the brush 31 rotates around a central axis J2 in the vertical direction. While cleaning of the substrate 9 is performed, by driving the motor 36, the brush 31 oscillates on the substrate 9 around a central axis J3 in the vertical direction. The motor 36 is connected to a not-shown elevating mechanism and the brush 31 moves in the vertical direction by driving the elevating mechanism. For convenience of illustration, FIG. 1 shows the shaft 35 and the motor 36 next to a container 41 discussed later.

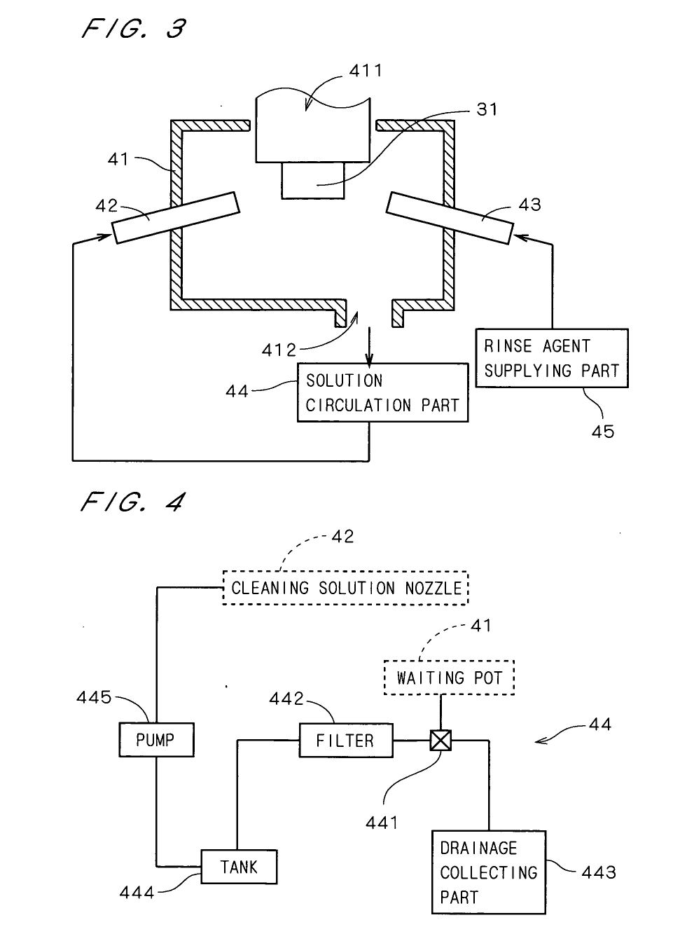

As shown in FIGS. 1 and 2, in the vicinity of the cup 22, the container (i.e., waiting pot) 41 is provided, where the brush 31 is disposed while cleaning of the substrate 9 with the brush 31 is not performed. FIG. 3 is an enlarged cross-sectional view showing the vicinity of the container 41.

As shown in FIG. 3, in the container 41, an opening 411 into which the brush 31 is inserted while cleaning the brush 31 and a liquid outlet 412 for draining liquid from the container 41 are formed. Further, in the container 41, a cleaning solution nozzle 42 for discharging predetermined cleaning solution (hereinafter, referred to as “second cleaning solution”) to the brush 31 and a rinse agent nozzle 43 for discharging predetermined rinse agent (for example, pure water) to the brush 31 are provided. To the cleaning solution nozzle 42, a solution circulation part 44 for supplying the second cleaning solution to the cleaning solution nozzle 42 and collecting the second cleaning solution applied to the brush 31 is connected. A rinse agent supplying part 45 for supplying the rinse agent is connected to the rinse agent nozzle 43, and the rinse agent nozzle 43 and the rinse agent supplying part 45 constitute a rinse agent applying part for applying the rinse agent to the brush 31. Detailed description on the second cleaning solution will be made later.

FIG. 4 is a block diagram showing a construction of the solution circulation part 44. The solution circulation part 44 has a switching valve 441 connected to the liquid outlet 412 of the container 41, and liquid from the container 41 is transmitted to a side of a filter 442 or a side of a drainage collecting part 443 by the switching valve 441. As discussed later, in a case where liquid from the container 41 is the second cleaning solution, the liquid is directed to the filter 442 and stored in a tank 444, and the second cleaning solution in the tank 444 is supplied to the cleaning solution nozzle 42 by a pump 445. In a case where liquid from the container 41 is the rinse agent, the liquid is directed to the drainage collecting part 443 and collected in the drainage collecting part 443.

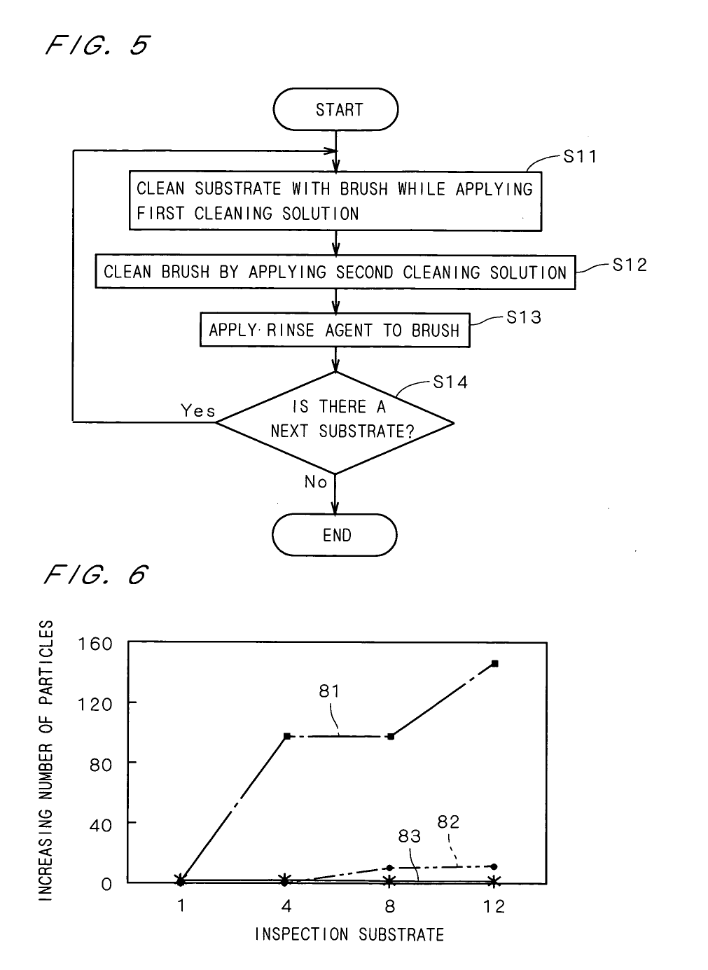

FIG. 5 is an operation flow of the substrate cleaning apparatus 1 for cleaning a substrate 9. When the substrate cleaning apparatus 1 of FIG. 1 cleans the substrate 9, first, the substrate 9 is placed on the holding part 21 while its main surface on which a pattern is formed faces the holding part 21. Specifically, in the preferred embodiment, a back surface of the substrate 9 is the upper surface to be cleaned. After the substrate 9 is placed on the holding part 21, the brush 31 moves up from the container 41 which is a waiting position of the brush 31, the motor 36 rotates the supporting arm 34 around the shaft 35 by a predetermined rotation angle, and then the brush 31 is located above the substrate 9 as indicated by a double-dashed line in FIG. 2. Subsequently, the brush 31 moves down and contacts with the upper surface of the substrate 9, and the cleaning nozzle 24 starts to apply the first cleaning solution onto the upper surface of the substrate 9. Further, rotation and oscillation of the brush 31 are started and rotation of the substrate 9 by the motor 23 is started. The upper surface of the substrate 9 is thereby scrubbed with the brush 31, particles (for example, particles such as silicon nitride (Si₃N₄), silicon oxide (SiO₂), or the like) which have adhered to the substrate 9 are removed from the upper surface of the substrate 9 together with the first cleaning solution. In this manner, cleaning of the upper surface of the substrate 9 is performed (Step S11). At this time, some removed particles adhere to the brush 31.

After cleaning of the upper surface of the substrate 9 is continued for a predetermined time, application of the first cleaning solution, rotation and oscillation of the brush 31, and rotation of the substrate 9 are stopped. The brush 31 moves up and away from the substrate 9, and an operation applying the brush 31 to the upper surface of the substrate 9 is finished. After the predetermined rinse agent is applied onto the substrate 9, the substrate 9 is rotated at high speed to dry the upper surface of the substrate 9, and the substrate 9 is unloaded from the substrate cleaning apparatus 1.

In parallel with the post-processing to the substrate 9 which has been cleaned with the brush 31 (that is application of the rinse agent, drying, or unloading of the cleaned substrate 9), the brush 31 used for cleaning the substrate 9 is located above the container 41 and moves down to be inserted into the container 41. Rotation of the brush 31 is started and the second cleaning solution is applied to the brush 31 from the cleaning solution nozzle 42 to clean the brush 31 (Step S112).

The second cleaning solution includes an anionic surfactant having a hydrophobic group and a hydrophilic group which becomes negative ion (anion) for electrolytic dissociation and the second cleaning solution is almost neutral at hydrogen ion exponent pH of 6.5. A zeta potential of particles removed from the upper surface of the substrate 9 in the second cleaning solution (i.e., the zeta potential is a potential in a so-called sliding surface of a diffusion layer around particle) becomes negative (for example, (−100) to (−10) millivolt (mV)) with reference to a potential of a ground measured by a predetermined measuring device due to effects of the anionic surfactant, and a zeta potential of fiber forming the brush 31 in the second cleaning solution also becomes negative (for example, (−100) to (−10) mV). Therefore, while cleaning of the brush 31 is performed, a repulsive force is generated between (fiber of) the brush 31 and particles which have adhered to the brush 31, and the particles adhering to the brush 31 are removed efficiently.

The second cleaning solution which is applied to the brush 31 during cleaning of the brush 31 is directed to the filter 442 shown in FIG. 4 through the liquid outlet 412 and the switching valve 441, and particles in the second cleaning solution are removed. The filtered second cleaning solution is stored in the tank 444. The second cleaning solution in the tank 444 is supplied to the cleaning solution nozzle 42, and the second cleaning solution is applied to the brush 31 again.

After cleaning of the brush 31 is continued for a predetermined time, discharge of the second cleaning solution from the cleaning solution nozzle 42 is stopped, and the rinse agent is applied to the brush 31 from the rinse agent nozzle 43 for a predetermined time with rotating the brush 31 (Step S13). With this operation, the second cleaning solution remaining on the brush 31 is replaced with the rinse agent.

After a next substrate 9 to be cleaned is placed on the holding part 21 (Step S14), cleaning of the substrate 9 with the cleaned brush 31 is performed (Step S11). At this time, since the second cleaning solution applied to the brush 31 is replaced with the rinse agent immediately after brush cleaning, this prevents the substrate 9. from being affected by the second cleaning solution remaining on the brush 31. After cleaning of the substrate 9 is finished, cleaning of the brush 31 is performed with applying the second cleaning solution (Step S12), and then the second cleaning solution remaining on the brush 31 is replaced with the rinse agent (Step S13). The above Steps S11 to S13 are repeated to all the substrates 9 to be cleaned (Step S14), and then, the operation for cleaning a substrate in the substrate cleaning apparatus 1 is completed.

As discussed above, in the substrate cleaning apparatus 1, the first cleaning solution is applied onto the substrate 9 and the substrate 9 is scrubbed with the brush 31, to clean the substrate 9. The second cleaning solution is applied to the brush 31 from the cleaning solution nozzle 42 while cleaning of the substrate 9 is not performed, whereby the brush 31 is cleaned. In a case where acid or alkaline liquid is used as cleaning solution for brush cleaning, the brush deteriorates rapidly due to cleaning solution. Also in a case where a zeta potential of a brush in cleaning solution for brush cleaning does not have the same polarity as a zeta potential of particles which have adhered to the brush while cleaning a substrate, attractive force is generated between the brush and the particles and it is difficult to remove the particles from the brush. Correspondingly, since the second cleaning solution used in the substrate cleaning apparatus 1 is almost neutral at the hydrogen ion exponent pH of 6.5 and a zeta potential of the brush 31 in the second cleaning solution has the same polarity as a zeta potential of particles which have adhered to the brush 31 while cleaning the substrate 9, it is possible to efficiently remove particles adhering to the brush 31 during cleaning of the substrate 9 with suppressing deterioration of the brush 31. It is also possible to utilize the substrate cleaning apparatus 1 for cleaning of a substrate where alkaline solution is unsuitable.

In the substrate cleaning apparatus 1, the solution circulation part 44 for collecting the second cleaning solution applied to the brush 31 to supply the second cleaning solution to the cleaning solution nozzle 42 after filtering the second cleaning solution is provided. Therefore, it is possible to use the second cleaning solution applied to the brush 31 again and reduce the cost for cleaning the substrate 9.

Next, discussion will be made on cleaning result of substrates in a case where operations of the above cleaning of a substrate are performed by using each of pure water (Deionized Water), ammonium hydroxide solution of 2% by weight, and the second cleaning solution which is anionic surfactant solution of 0.4% by weight as cleaning solution for brush cleaning. Twelve substrates are processed relative to each cleaning solution for brush cleaning, and brush cleaning with each cleaning solution is performed every time when cleaning of one substrate is performed, as discussed above. Four substrates (hereinafter, referred to as “inspection substrates”) which are first, fourth, eighth, and twelfth processed substrates are high cleaned, where few adhering particles exist (the diameter of the particle is 0.12 micrometer (μm) or more), and the other substrates have many adhering particles and are contaminated.

FIG. 6 is a graph showing a cleaning result of inspection substrates in a case of using each cleaning solution. 1, 4, 8, and 12 of a horizontal axis in FIG. 6 respectively correspond to the first, fourth, eighth, and twelfth inspection substrates. A vertical axis in FIG. 6 indicates an increasing number of particles adhering to an inspection substrate between before and after cleaning, that is, the number of particles transferred to an inspection substrate from another substrate through a brush. The lines 81, 82, and 83 in FIG. 6 indicate cleaning result in cases of using pure water, ammonium hydroxide solution, and the second cleaning solution, respectively.

As shown in FIG. 6, with respect to each of pure water, ammonium hydroxide solution, and the second cleaning solution, naturally, the increasing number of particles in the first inspection substrate is approximately 0. In the case of using pure water, in the fourth inspection substrate which is processed after second and third contaminated substrates, the increasing number of particles is 99. This shows that particles adhering to the brush during cleaning of second and third substrates are not removed in brush cleaning just after cleaning of the second and third substrates and remain on the brush, and the particles are transferred to the fourth inspection substrate. On the other hand, in the cases of ammonium hydroxide solution and the second cleaning solution, the increasing numbers of particles in the fourth inspection substrates are approximately 0.

With respect to the eighth inspection substrate which is processed after fifth to seventh contaminated substrates, in pure water, the increasing number of particles is 102, in ammonium hydroxide solution, the increasing number of particles is 10, however, in the second cleaning solution, the increasing number of particles is approximately 0. Further, the increasing number of particles in the twelfth inspection substrate is 151 in pure water, 9 in ammonium hydroxide solution, however, approximately 0 in the second cleaning solution. This shows that it is possible to more stably suppress transfer of particles to an inspection substrate through a brush in the second cleaning solution than pure water or ammonium hydroxide solution. Since a concentration in the second cleaning solution is lower than that in ammonium hydroxide solution (i.e., the second cleaning solution has a small amount of solute), it is possible to reduce a processing cost for cleaning a substrate. Naturally, a concentration in anionic surfactant solution used as the second cleaning solution may be changed as appropriate.

Though the preferred embodiment of the present invention has been discussed above, the present invention is not limited to the above-discussed preferred embodiment, but allows various variations.

From the viewpoint of suppressing deterioration of the brush 31, the second cleaning solution used in the substrate cleaning apparatus 1 is allowed to have hydrogen ion exponent pH which is not lower than 6.0 and not higher than 7.5. The brush 31 may be made of nylon other than polyvinyl alcohol, and also in this case, a zeta potential of the brush 31 in the second cleaning solution has the same polarity as a zeta potential of particles which have adhered to the brush 31 while cleaning the substrate 9, it is therefore possible to remove particles adhering to the brush 31 efficiently. Further, only if a zeta potential of the brush 31 has the same polarity as a zeta potential of particles adhering to the brush 31, it is also possible to make the brush 31 for cleaning substrates with another fiber other than polyvinyl alcohol and nylon. In the substrate cleaning apparatus 1, since the second cleaning solution is almost neutral, there are few restrictions on materials for the brush 31.

Though in the above preferred embodiment a substrate cleaning mechanism for cleaning the substrate 9 comprises the brush 31, the cleaning nozzle 24, and the motors 23, 33, and 36, the substrate cleaning mechanism is allowed to have other construction. For example, the motor 33 is omitted and the substrate 9 can be scrubbed with the brush 31 only by driving the motors 23, 36. In other words, the substrate cleaning mechanism may be any construction only if the substrate 9 is scrubbed with the brush 31 while applying the first cleaning solution onto the substrate 9. The object to be cleaned by the substrate cleaning mechanism can be an edge or the like of the substrate 9 other than the upper surface of the substrate 9.

A brush cleaning mechanism for cleaning the brush 31 may be implemented by, for example, the container 41 for storing the second cleaning solution, other than the cleaning solution nozzle 42 which applies the second cleaning solution to the brush 31, and in this case, the brush 31 is immersed in the container 41 and cleaned (by so-called dipping).

Cleaning of the brush 31 is not necessarily performed in the container 41, the second cleaning solution is discharged from a cleaning nozzle provided in the vicinity of the cup 22 to the brush 31 positioned above the holding part 21, without placing the substrate 9 on the holding part 21, whereby cleaning of the brush 31 is performed. In other words, cleaning of the brush 31 can be performed while cleaning of the substrate 9 is not performed, that is, the brush 31 is not applied to the substrate 9.

The rinse agent applying part for applying the rinse agent to the brush 31 may be implemented by, for example, a container in which the rinse agent is stored, other than the rinse agent nozzle 43 and the rinse agent supplying part 45, and in this case, the second cleaning solution remaining on the brush 31 is replaced with the rinse agent by immersing the brush 31 in the container.

The basic mechanism of the substrate cleaning apparatus 1 may be adopted to a so-called batch-type apparatus where a plurality of substrates 9 are processed at one time, other than a single wafer type apparatus where a plurality of substrates 9 are cleaned one by one. A substrate to be cleaned in the substrate cleaning apparatus can be a glass substrate, a printed circuit board, or the like, other than a semiconductor substrate.

While the invention has been shown and described in detail, the foregoing description is in all aspects illustrative and not restrictive. It is therefore understood that numerous modifications and variations can be devised without departing from the scope of the invention.

This application claims priority benefit under 35 U.S.C. Section 119 of Japanese Patent Application No. 2005-90761 filed in the Japan Patent Office on Mar. 28, 2005, the entire disclosure of which is incorporated herein by reference.

What is claimed is:

1. A substrate cleaning apparatus for cleaning a substrate, comprising:
a substrate cleaning mechanism for cleaning a substrate by applying first cleaning solution onto said substrate and scrubbing said substrate with a brush made of resin; and
a brush cleaning mechanism for cleaning said brush by applying second cleaning solution to said brush while cleaning of a substrate with said brush is not performed, said second cleaning solution having hydrogen ion exponent pH which is not lower than 6.0 and not higher than 7.5, wherein
a zeta potential of said brush in said second cleaning solution has the same polarity as a zeta potential of particles which have adhered to said brush while cleaning a substrate.

2. The substrate cleaning apparatus according to claim 1, wherein
said second cleaning solution includes an anionic surfactant.

3. The substrate cleaning apparatus according to claim 1, wherein
said brush is made of polyvinyl alcohol or nylon.

4. The substrate cleaning apparatus according to claim 1, further comprising:
a rinse agent applying part for applying a rinse agent to said brush to replace said second cleaning solution remaining on said brush with said rinse agent immediately after cleaning by said brush cleaning mechanism.

5. The substrate cleaning apparatus according to claim 1, further comprising:
a solution circulation part for collecting said second cleaning solution applied to said brush to supply said second cleaning solution to said brush cleaning mechanism after filtering said second cleaning solution.

6. A substrate cleaning method for cleaning a substrate, comprising the steps of:
a) cleaning a substrate by applying first cleaning solution onto said substrate and scrubbing said substrate with a brush made of resin; and
b) cleaning said brush by applying second cleaning solution to said brush while cleaning of a substrate with said brush is not performed, said second cleaning solution having hydrogen ion exponent pH which is not lower than 6.0 and not higher than 7.5, wherein
a zeta potential of said brush in said second cleaning solution has the same polarity as a zeta potential of particles which have adhered to said brush while cleaning a substrate.

7. The substrate cleaning method according to claim 6, wherein
said second cleaning solution includes an anionic surfactant.

8. The substrate cleaning method according to claim 6, wherein
said brush is made of polyvinyl alcohol or nylon.

9. The substrate cleaning method according to claim 6, further comprising the step of:
applying a rinse agent to said brush to replace said second cleaning solution remaining on said brush with said rinse agent immediately after said step b).

10. The substrate cleaning method according to claim 6, wherein
in said step b), said second cleaning solution applied to said brush is collected to apply said second cleaning solution to said brush again after filtering said second cleaning solution.
